(19) United States
(12) Patent Application Publication
(10) Pub. No.: US 2026/0322799 A1
(43) Pub. Date: Oct. 15, 2026

(54) DEPENDENT CREDENTIALS

(71) Applicant: ASSA ABLOY AB, Stockholm (SE)

(72) Inventors: Adrian Castillo, Saint-Mandé (FR); Béatrice Salaun, Elancourt (FR); Marie-Cécile Rousseau, Suresness (FR)

(21) Appl. No.: 19/107,608

(22) PCT Filed: Sep. 1, 2022
(86) PCT No.: PCT/EP2022/074379

§ 371 Date: Feb. 28, 2025

(51) Int. Cl. H04L 9/40

(52) U.S. Cl. CPC H04L 63/0823; H04L 63/10

(57) ABSTRACT

Methods and systems are provided for performing operations comprising: storing a plurality of credentials on a client device; establishing, locally on the client device, a dependency relationship between a first credential of the plurality 7 of credentials and a second credential of the plurality of credentials; determining, by the client device, that the first credential has been used to access a secure resource; and in response to determining that the first credential has been used to access the secure resource, triggering an access condition associated with the second credential based on the dependency relationship established between the first and second credentials

### BACKGROUND

Digital identity credentials are hosted in devices that have storage and computing capabilities like NFC smart cards, USB dongles or smart devices (e.g., smart phones, smart watches, and various other Internet-connected devices). Such electronic credentials are used in physical access applications to unlock electronic smart door locks (used in, e.g., hotels, enterprises), in logical access applications to access computers systems and data (e.g. log in to a work laptop, access banking services on the Internet), present digital identities of users (e.g., digital driver's licenses), and to present electronic tickets for entering ticketed events (e.g., concerts, sporting events, and so forth).

### SUMMARY

In some aspects, a method is provided comprising: storing a plurality of credentials on a client device; establishing, locally on the client device, a dependency relationship between a first credential of the plurality of credentials and a second credential of the plurality of credentials; determining, by the client device, that the first credential has been used to access a secure resource; and in response to determining that the first credential has been used to access the secure resource, triggering an access condition associated with the second credential based on the dependency relationship established between the first and second credentials.

In some cases, the method includes unlocking the second credential in response to triggering the access condition to enable use of the second credential to access another secure resource.

In some cases, the second credential is unlocked for a threshold period of time.

In some cases, the method includes preventing use of the second credential until the first credential is used to access the secure resource.

In some cases, the method includes locking the second credential in response to triggering the access condition to prevent use of the second credential to access another secure resource. In some cases, the second credential is locked for a threshold period of time.

In some cases, the secure resource includes a physical access control system (PACS), wherein the first credential comprises an electronic key to enter the PACS, and wherein the second credential comprises an electronic certificate to log in to a computing device within a physical region protected by the PACS. In some cases, the electronic certificate enables a user to log in to the computing device after the electronic key is used to enter the physical region protected by the PACS. In some cases, the electronic certificate prevents a user from logging into the computing device in response to determining that the electronic key has been used to leave the physical region protected by the PACS.

In some cases, the method includes receiving a request to use the second credential to access another secure resource; and in response to receiving the request, accessing the dependency relationship to identify one or more access conditions associated with the second credential, the one or more access conditions being associated with one or more credentials of the plurality of credentials, the one or more credentials comprising the first credential.

In some cases, the method includes querying the first credential based on the dependency relationship to determine a last time that the first credential was used; and in response to determining that the last time the first credential was used is within a threshold period of time, enabling use of the second credential to access the another secure resource.

In some cases, the method includes receiving a request to use the first credential to access the secure resource; in response to receiving the request, establishing a physical or wireless connection with a physical access control system (PACS); and sending the first credential over a physical or wireless connection from the client device to the PACS to obtain access to the secure resource. The access condition can enable or disable use of the second credential based on proximity of the client device to an external device.

In some cases, the method includes determining the proximity of the client device to the external device using a short-range communication protocol comprising at least one of Bluetooth, ultra-wideband (UWB) communication protocol, or Near Field Communication (NFC). The first credential can include an identity document comprising a digital signature and validity period, and wherein the second credential comprises a boarding document.

In some cases, the method includes triggering the access condition by validating the boarding document and maintaining the boarding document in a valid state for the validity period in response to determining that the identity document has been authenticated based on the digital signature. The secure resource includes a physical access control system (PACS), wherein the first credential includes an electronic key to enter the PACS, and wherein the second credential includes a one-time-password (OTP) generated by an OTP generator to obtain access to a computing device over a virtual private network (VPN). In such cases, the method further includes disabling the OTP generator in response to determining that the electronic key has been used to enter a physical region protected by the PACS.

In some cases, the first credential is associated with a specialized training certificate of a user of the client device. In such cases, triggering the access condition includes unlocking the second credential for accessing a physical access control system (PACS). The method includes receiving a request to use the second credential to access the PACS; in response to receiving the request, determining that the specialized training certificate associated with the first credential is valid; and enabling use of the second credential to access the PACS in response to determining that the specialized training certificate associated with the first credential is valid.

In some cases, a system and non-transitory computer-readable medium comprising non-transitory computer-readable instructions are provided for performing the above methods.

### BRIEF DESCRIPTION OF THE DRAWINGS

FIG. 1 is a block diagram of an example authentication system, according to some embodiments.

FIG. 2 is a block diagram of an example client device, according to some embodiments.

FIGS. 3 and 4 are example outputs of the authentication system, according to some embodiments.

FIG. 5 illustrates example operations of the authentication system, according to some embodiments.

FIG. 6 is a block diagram illustrating an example software architecture, which may be used in conjunction with various hardware architectures herein described.

FIG. 7 is a block diagram illustrating components of a machine, according to some example embodiments.

### DETAILED DESCRIPTION

Example methods and systems for an authentication system are described. In the following description, for purposes of explanation, numerous specific details are set forth in order to provide a thorough understanding of example embodiments. It will be evident, however, to one of ordinary skill in the art that embodiments of the disclosure may be practiced without these specific details.

Typical secure access systems enable access to secure or protected resources by exchanging a set of credentials over a secure channel, such as a Bluetooth Low Energy (BLE) channel. This process is usually initiated when a user request is received by a client device to access a selected resource. At this point, a secure channel with some sort of back-end system that validates the identity credentials is established and used to perform all of the operations needed to provide access to the selected resource. In some cases, complex rules are created and managed by the back-end server to enable/disable use of certain credentials. Processing such rules can take time and can require a secure connection to remain active while the rules are processed.

Establishing and maintaining the connection with the back-end system can be costly and inefficient. Also, in some cases, the latency for obtaining a response while rules are processed, can result in a poor user experience. Also, if the secure channel is compromised because the secure channel needs to remain active while the complex rules are processed, the user's credentials can be stolen or copied by another device and used to access the same resource at a later time. Some systems attempt to increase the speed at which access is granted by upgrading software and hardware resources. This can lead to increased expenses and still only reduces the delays the users experience by insignificant amounts.

In certain cases, users may desire to access a protected resource but the infrastructure required to establish a secure connection to have the complex rules processed to enable/disable access to a protected resource may not be available. For example, the user may be in a remote location with minimal network access and, in such cases, the user is either unable to access the protected resource. This may be because of the lack of a secure connection to a remote server to process the complex rules to determine whether or not to grant the user access. Alternatively, the system may fall back to granting access based on simpler rules processed locally that may result in unauthorized access, for example granting access with a credential that has been flagged as lost or stolen in the back-end system.

The disclosed embodiments provide an intelligent solution that addresses the above technical problems and challenges. Particularly, the disclosed technical solution stores a set of credentials locally on a client device and establishes local dependencies between the credentials. These dependencies ensure that one set of credentials can validate and/or invalidate use of another set of credentials when certain conditions are met. For example, a set of complex dependency rules can be stored on a local client device that also stores the set of credentials. The client device can locally process the rules to enable access to a second credential when a first credential is used or authenticated. This eliminates the need to establish secure connections with a backend to process complex rules to enable/disable certain credentials.

In this way, the disclosed techniques substantially reduce the amount of information exchanged over a network and operations performed to grant/deny access to a secure resource when a user request to access the secure resource is received. This expedites the process of granting access to a secure or protected resource and increases the overall efficiency of operating the device. Also, because the credential dependencies are locally processed on the client device to enable/disable certain credentials, there is minimal risk of compromising a user's credentials as less information is exchanged over a network. By storing the dependencies locally on the device, the need to establish a secure connection with a backend is reduced or eliminated, which enables users to access protected resources even in situations where network connections are restricted or limited. As such, the disclosed techniques provide a low-cost solution to expediting operations performed in granting/denying a user access to a secure or protected resource.

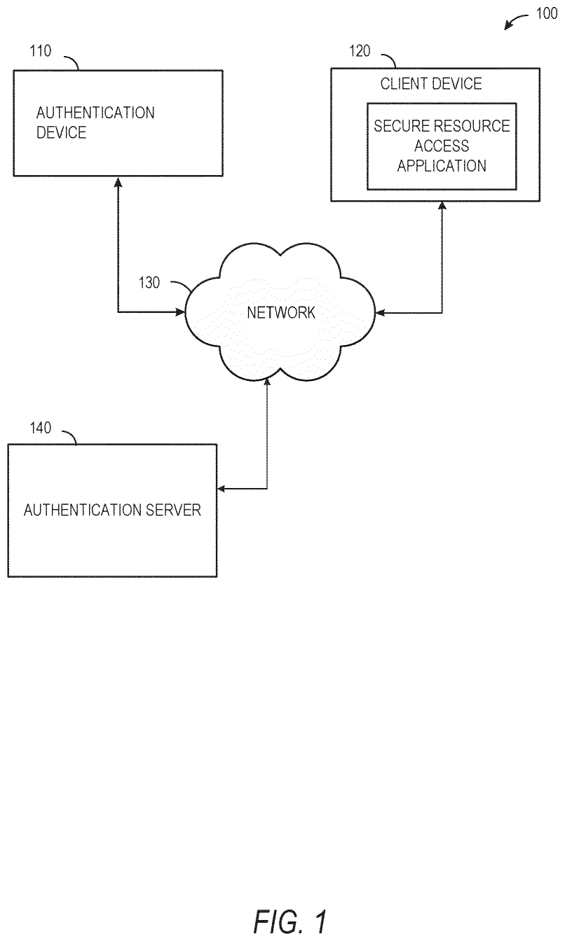

FIG. 1 is a block diagram showing an example authentication system 100, according to various example embodiments. The authentication system 100 can include a client device 120, an authentication device 110 that can be used to control access to a protected asset or secure resource, such as through a lockable door, and an authentication server 140 that are communicatively coupled over a network 130 (e.g., Internet, BLE, ultra-wideband (UWB) communication protocol, Near Field Communication (NFC), and/or telephony network).

The client device 120 and the authentication device 110 and/or the authentication server 140 can be communicatively coupled via electronic messages (e.g., packets exchanged over the Internet, BLE, UWB, NFC, WiFi direct or any other protocol). While FIG. 1 illustrates a single authentication device 110 and a single client device 120, it is understood that a plurality of authentication devices 110 and a plurality of client devices 120 can be included in the authentication system 100 in other embodiments.

The authentication device 110 can include any one or a combination of an IoT device, a database, a website, a server hosting a website at a URL address, a physical access control device, logical access control device, governmental entity device, ticketing event device, and residential smart lock and/or other Bluetooth or NFC or UWB based smart device. In some examples, the authentication device 110 can be part of the client device 120 and/or the authentication server 140. In some examples, the authentication device 110 is external to the client device 120 and communicates with the client device 120 and/or the authentication server 140 over a network 130.

The authentication device 110 can protect a secure area, asset or resource and can be configured to receive a digital credential or digital credentials from the client device 120. The authentication device 110 can verify that the received digital credential or digital credentials is/are authorized to access the secure area, such as by communicating with the authentication server 140. In response, the authentication device 110 can grant access to the secure area or protected resource. The authentication device 110 itself or by communication with the authentication server 140 can verify whether the digital credential or digital credentials is/are authorized to access the identified secure resource. If so, the authentication device 110 can grant access to the client device 120 (e.g., by unlocking an electronic door lock) or individual associated with the client device 120.

In some cases, the digital credential or digital credentials are transmitted by the client device 120 to the authentication device 110 after locally verifying that the digital credential or digital credentials satisfy a dependency relationship that is stored on the client device 120. For example, the client device 120 can establish dependency relationships between two or more credentials that are stored on the client device 120. Establishing dependency relationships can condition activation or validity of a first credential on the use, existence, or validity of a second credential. Namely, the first credential may be inactive and unavailable for use (e.g., cannot be transmitted to the authentication device 110) until the second credential is used (e.g., to access a secure area protected by the authentication device 110 or another authentication device 110). The client device 120 can determine that the second credential has been used and, in response, can access the dependency relationships associated with the second credential to identify one or more other credentials (e.g., including the first credential) that are associated with the second credential. The client device 120 can activate/deactivate each one of the one or more other credentials in response to determining that the second credential has successfully been used. In such cases, the client device 120 can immediately send the first credential to the authentication device 110 and/or can wait for a specific user request to use the first credential before sending the first credential to the authentication device 110.

In some examples, the first credential is only available for use (based on the second credential being used) for a validity period or threshold period of time (e.g., 2 hours). After the validity period or threshold period of time elapses, the first credential is invalidated to prevent use of the first credential. In some examples, the use of the second credential invalidates the first credential. Namely, the first credential can remain active and available for use until the second credential is used. In such cases, the client device 120 can determine that the second credential has been used and, in response, can access the dependency relationships associated with the second credential to identify one or more other credentials (e.g., including the first credential) that are associated with the second credential. The client device 120 can deactivate the first credential in response to determining that the second credential has successfully been used. For example, the first credential can include an OTP generated by an OTP generator to access a virtual private network (VPN) outside of an office location. The second credential can be used to access a restricted area (e.g., the office location). Once the second credential has been used to enter the restricted area, the first credential is deactivated to prevent the OTP generator from generating an OTP so that the user is unable to access the VPN while at the office location (e.g., the restricted area). The client device 120 can determine that the first credential has been used again to leave the restricted area and, in response, can re-activate the second credential to enable the user to access the VPN while outside of the office location.

In some cases, some or all of the components and functionality of the authentication device 110 are included as part of the authentication server 140. In some cases, the authentication device 110 is part of the secure resource (e.g., door lock) or secure asset or protected area. In some cases, the authentication device 110 is configured to communicate via a secure channel or private link with the secure resource (e.g., door lock) or secure asset or protected area to provide instructions to grant access, such as to open the lock. A client device 120 may be, but is not limited to, an NFC powered microcontroller device like a smart card or USB dongle, a mobile phone, desktop computer, laptop, portable digital assistant (PDA), smart phone, a wearable device (e.g., a smart watch), tablet, ultrabook, netbook, laptop, multi-processor system, microprocessor-based or programmable consumer electronics, or any other communication device that a user may use to access the network 130.

For example, the authentication device 110 (and/or the client device 120) can include or be associated with a physical access control device that can include or be associated with an access reader device connected to a physical resource (e.g., a door locking mechanism or backend server) that controls the physical resource (e.g., door locking mechanism). The physical resource associated with the physical access control device can include a door lock, an ignition system for a vehicle, or any other device that grants or denies access to a secure resource or component, such as a physical component and that can be operated to grant or deny access to the secure resource or component. For example, in the case of a door lock, the physical access control device can deny access, in which case the door lock remains locked and the door cannot be opened, or can grant access, in which case the door lock becomes unlocked to allow the door to be opened. As another example, in the case of an ignition system, the physical access control device can deny access, in which case the vehicle ignition system remains disabled and the vehicle cannot be started, or can grant access, in which case the vehicle ignition becomes enabled to allow the vehicle to be started.

Physical access control covers a range of systems and methods to govern access, for example by people, to secure areas or secure assets. Physical access control includes identification of authorized users or devices (e.g., vehicles, drones, etc.) and actuation of a gate, door, or other facility used to secure an area or actuation of a control mechanism, e.g., a physical or electronic/software control mechanism, permitting access to a secure asset. The physical access control device forms part of physical access control systems (PACS), which can include a reader (e.g., an online or offline reader) that holds authorization data and can be capable of determining whether credentials (e.g., from credential or key devices such as radio frequency identification (RFID) chips in cards, fobs, or personal electronic devices such as mobile phones) are authorized for an actuator or control mechanism (e.g., door lock, door opener, software control mechanism, turning off an alarm, etc.), or PACS can include a host server to which readers and actuators are connected (e.g., via a controller) in a centrally managed configuration. In centrally managed configurations, readers can obtain credentials from credential or key devices and pass those credentials to the PACS host server. The host server then determines whether the credentials authorize access to the secure area or secure asset and commands the actuator or other control mechanism accordingly.

In general, the authentication device 110 can include one or more of a memory, a processor, one or more antennas, a communication module, a network interface device, a user interface, and a power source or supply. The memory of the authentication device 110 can be used in connection with the execution of application programming or instructions by the processor of the authentication device 110, and for the temporary or long-term storage of program instructions or instruction sets, keys used to validate credentials, token or authorization data, or access control data or instructions. For example, the memory can contain executable instructions that are used by the processor to run other components of authentication device 110 and/or to make access determinations based on credential or authorization data.

The memory of the authentication device 110 can comprise a computer-readable medium that can be any medium that can contain, store, communicate, or transport data, program code, or instructions for use by or in connection with authentication device 110. The computer-readable medium can be, for example but is not limited to, an electronic, magnetic, optical, electromagnetic, infrared, or semiconductor system, apparatus, or device. More specific examples of suitable computer-readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), Dynamic RAM (DRAM), any solid-state storage device, in general, a compact disc read-only memory (CD-ROM), or other optical or magnetic storage device.

The processor of the authentication device 110 can correspond to one or more computer processing devices or resources. For instance, the processor can be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor can be provided as a microprocessor, Central Processing Unit (CPU), or plurality of microprocessors or CPUs that are configured to execute instructions sets stored in an internal memory and/or memory of the authentication device 110.

The antenna of the authentication device 110 can correspond to one or multiple antennas and can be configured to provide for secure and/or unsecure wireless communications between authentication device 110 and a credential or key device (e.g., client device 120). The antenna can be arranged to operate using one or more wireless communication protocols and operating frequencies including, but not limited to, the IEEE 802.15.1, Bluetooth, Bluetooth Low Energy (BLE), NFC, ZigBee, GSM, CDMA, Wi-Fi, RF, UWB, and the like. By way of example, the antenna(s) can be RF antenna(s), and as such, may transmit/receive RF signals through free-space to be received/transferred by a credential or key device having an RF transceiver. In some cases, at least one antenna is an antenna designed or configured for transmitting and/or receiving UWB signals (referred to herein for simplicity as a “UWB antenna”) such that the reader can communicate using UWB techniques with the client device 120.

A communication module of the authentication device 110 can be configured to communicate according to any suitable communications protocol with one or more different systems or devices either remote or local to authentication device 110, such as one or more client devices 120. In some cases, the communication module communicates over a secure channel (e.g., secure BLE or NFC channel) with a client device 120, in which case all of the exchanged data is encrypted (e.g., end-to-end). In some cases, the communication module communicates over an unsecure channel (e.g., unsecure, public or open BLE or NFC channel) with a client device 120, in which case all or a portion of the exchanged data is unencrypted.

The network interface device of the authentication device 110 includes hardware to facilitate communications with other devices, such as a one or more client devices 120 over a communication network, such as network 130, utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., IEEE 802.11 family of standards known as Wi-Fi, IEEE 802.16 family of standards known as WiMax), IEEE 802.15.4 family of standards, and peer-to-peer (P2P) networks, among others. In some examples, network interface device can include an Ethernet port or other physical jack, a Wi-Fi card, a Network Interface Card (NIC), a cellular interface (e.g., antenna, filters, and associated circuitry), or the like. In some examples, network interface device can include a plurality of antennas to wirelessly communicate using at least one of single-input multiple-output (SIMO), multiple-input multiple-output (MIMO), or multiple-input single-output (MISO) techniques.

A user interface of the authentication device 110 can include one or more input devices and/or display devices. Examples of suitable user input devices that can be included in the user interface include, without limitation, one or more buttons, a keyboard, a mouse, a touch-sensitive surface, a stylus, a camera, a microphone, etc. Examples of suitable user output devices that can be included in the user interface include, without limitation, one or more LEDs, an LCD panel, a display screen, a touchscreen, one or more lights, a speaker, and so forth. It should be appreciated that the user interface can also include a combined user input and user output device, such as a touch-sensitive display or the like.

The network 130 may include, or operate in conjunction with, an ad hoc network, an intranet, an extranet, a virtual private network (VPN), a LAN, a wireless network, a wireless LAN (WLAN), a wide area network (WAN), a wireless WAN (WWAN), a metropolitan area network (MAN), BLE, UWB, the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other short range or long range protocols, or other data transfer technology.

In some embodiments, the client device 120 implements a secure resource access application. The secure resource access application may run on the client device 120 and can be accessed by a user of the client device 120. The secure resource access application can allow an operator or user to access a resource or asset protected by the authentication device 110. The secure resource access application can communicate with one or more authentication servers 140 to obtain one or more credentials associated with a user and to receive a dependency relationship associated with the one or more credentials. The secure resource access application can control access to the credentials by activating and deactivating certain credentials that are stored on the client device 120 based on the dependency relationship. The secure resource access application allows the credentials to locally communicate with each other through device objects.

The secure resource access application can receive a request to use the first credential to access the secure resource and, in response, can establish a physical or wireless connection with the PACS device. The secure resource access application sends the first credential over the physical or wireless connection from the client device 120 to the PACS to obtain access to the secure resource. Once a first credential is used by the client device 120 (e.g., to access a protected resource), the secure resource access application can access the dependency relationship storage to determine whether a second credential is dependent on use or existence of the first credential. In response to determining that the second credential is dependent on use of the first credential, the secure resource access application triggers an access condition associated with the second credential. For example, the secure resource access application can activate (unlock) the second credential to enable use of the second credential for a threshold period of time in response to determining that the first credential has been used or exists. As another example, the secure resource access application can deactivate (lock) the second credential to prevent use of the second credential for a threshold period of time in response to determining that the first credential has been used or exists.

In some examples, the secure resource accessed by the first credential includes a PACS device. In such cases, the first credential includes an electronic key to enter the PACS, such as by passing through a gate controlled by the PACS device. The second credential can include an electronic certificate that is used to login to a computing device within a physical region protected by the PACS. The electronic certificate can enable a user to log in to the computing device after the electronic key is used to enter the physical region protected by the PACS. In such cases, the secure resource access application can deactivate the electronic certificate to prevent the user from logging into the computing device in response to determining that the first credential (e.g., the electronic key) has been used to leave the physical region protected by the PACS.

In some examples, the secure resource access application receives a request to use the second credential to access another secure resource different from the secure resource accessed using the first credential. The secure resource access application can, in response to receiving the request, access the dependency relationship to identify one or more access conditions associated with the second credential. The one or more access conditions can be associated with one or more credentials of a plurality of credentials that include the first credential. The secure resource access application can locally on the client device 120 (and without involving an external server) query the first credential (or an object associated with the first credential) based on the dependency relationship to determine a last time that the first credential was used. The secure resource access application, in response to determining that the last time the first credential was used is within a threshold period of time, enables use of the second credential to access the another secure resource.

In some examples, the secure resource access application, based on the access condition of the second credential, enables or disables use of the second credential based on proximity of the client device to an external device. For example, the second credential can be activated for use in response to the first credential being used or being stored in a valid state on the client device 120. The secure resource access application can determine that an additional condition is associated with the second credential. The additional condition can include a measure of proximity to an external device, such as a PACS reader. The second credential remains in an invalid or deactivated state until the secure resource access application receives a signal from the external device indicating that the external device is within a threshold proximity to the client device 120. In some cases, the proximity is measured based on a UWB protocol. In some cases, the proximity of the client device to the external device is measured or determined using a short-range communication protocol including at least one of BLE, a UWB communication protocol, or NFC.

In some examples, the first credential includes an identity document with a digital signature and validity period, such as a passport document. The second credential can include a boarding document, such as a boarding pass for an airplane. The secure resource access application triggers the access condition by validating the boarding document and maintaining the boarding document in a valid state for the validity period in response to determining that the identity document has been authenticated based on the digital signature.

In some examples, the first credential is associated with a specialized training certificate of a user of the client device 120, such as weapons training or hazardous materials training. In such cases, the secure resource access application triggers the access condition by unlocking the second credential for accessing a PACS device that restricts access to a physical area in which only personnel with specialized training (for whom the specialized training certificate has been issued) are allowed inside. The secure resource access application can receive a request to use the second credential to access the PACS of the physical area requiring specialized training. The secure resource access application, in response to receiving the request, determines that the specialized training certificate associated with the first credential is valid. At this point, the secure resource access application sends the first credential over a physical or wireless connection from the client device 120 to the PACS device to obtain access to the secure resource (e.g., to enter the restricted physical area).

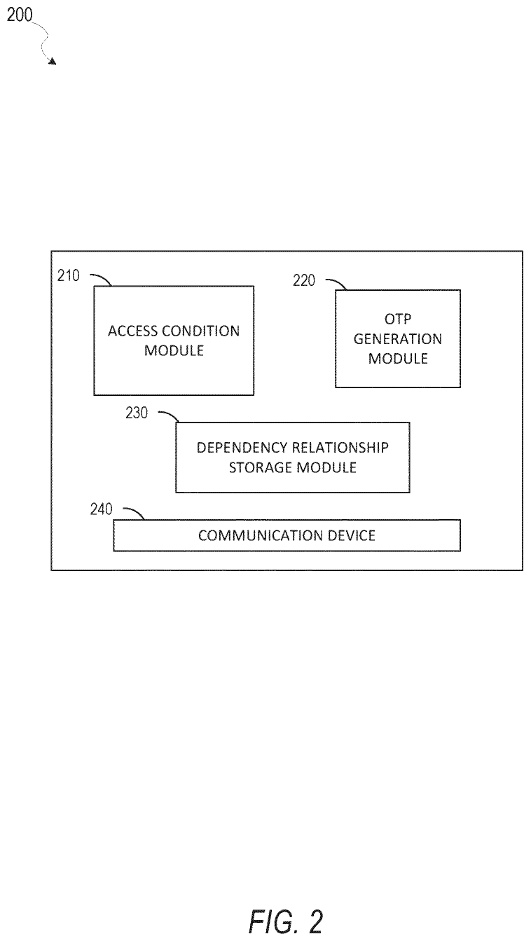

FIG. 2 is a block diagram of an example client device 200, according to some embodiments. The client device 200 can include some or all of the same features as the client device 120. The authentication device 200 includes an access condition module 210, an OTP generation module 220, a dependency relationship storage module 230, and a communication device 240.

The client device 200 can communicate with one or more authentication servers (e.g., authentication server 140) via the communication device 240 to obtain respective credentials for a given user of the client device 200. The authentication server 140 can receive a token from the client device 200 that identifies the given user. In response, the authentication server 140 can determine whether the token matches a previously stored token. If the authentication server 140 finds a previously stored token that matches the token received from the client device 200, the authentication server 140 retrieves the credential (e.g., the digital credential) associated with the token. The digital credential can include an identity document, a boarding pass, a certificate of specialized training completion, an OTP generator seed, an electronic certificate, a key to an electronic door lock, and/or any additional types of digital credentials. The authentication server 140 determines whether the digital credential is associated with a condition and/or has a dependency relationship with a second digital credential. In response to determining that the digital credential has a dependency relationship with the second digital credential, the authentication server 140 obtains the criteria and/or conditions associated with the relationship. The authentication server 140 transmits the digital credential along with any dependency relationships associated with the digital credential to the client device 200.

The client device 200 receives the digital credential via the communication device 240 along with the dependency relationship associated with the digital credential. The client device 200 stores the digital credential that is received among a plurality of digital credentials in a memory (not shown). The client device 200 processes the dependency relationship associated with the digital credential and stores the dependency relationship in the dependency relationship storage module 230. For example, the client device 200 can store an identifier of the digital credential (e.g., a first digital credential) in a database along with the identifiers of one or more other digital credentials and the conditions for activating or deactivating the one or more other digital credentials based on use or existence of the first digital credential.

In some examples, the client device 200 can query the memory or search the plurality of previously stored digital credentials to determine whether a second digital credential identified in the received dependency relationship is valid or stored or exists as part of the previously stored digital credentials. In response to determining that the second digital credential is not included in the list of previously stored and valid digital credentials, the client device 200 can communicate via the communication device 240 with the authentication server 140 (associated with the second digital credential) to obtain the second digital credential. The authentication server 140 that provides the second digital credential can be the same or different from the authentication server 140 that provides the first digital credential.

The authentication server 140 of the second digital credential can receive a token from the client device 200 that identifies the given user. In response, the authentication server 140 can determine whether the token matches a previously stored token. If the authentication server 140 finds a previously stored token that matches the token received from the client device 200, the authentication server 140 retrieves the second digital credential associated with the token. The second digital credential can include an identity document, a boarding pass, a certificate of specialized training completion, an OTP generator seed, an electronic certificate, a key to an electronic door lock, and/or any additional types of digital credentials. The authentication server 140 determines whether the second digital credential is associated with a condition and/or has a dependency relationship with other digital credentials. In response to determining that the second digital credential has a dependency relationship with other digital credentials, the authentication server 140 obtains the criteria and/or conditions associated with the relationship. The authentication server 140 transmits the second digital credential along with any dependency relationships associated with the digital credential to the client device 200. As mentioned before with respect to the first digital credential, the client device 200 receives the second digital credential and adds the second digital credential to the list of previously stored digital credentials and, optionally, updates the dependency relationship storage module 230 to include a reference to the second digital credential and its relationships to other digital credentials.

The OTP generation module 220 generates an OTP (e.g., a set of random numbers) by applying a function to a digital credential and the one or more of the secure resources or assets protected by an authentication device 110. The OTP can be used to access a secure online resource and/or to obtain secure information from an online resource. In some examples, the OTP generation module 220 is activated or deactivated in response to detecting use of a particular digital credential. For example, the client device 200 can receive a user request to access the first digital credential to enter a protected area. In response, the client device 200 retrieves the first digital credential and determines whether access conditions associated with the first digital credential are satisfied. For example, the client device 200 processes the first digital credential using the access condition module 210. The access condition module 210 queries the dependency relationship storage module 230 using an identifier of the first digital credential to retrieve one or more dependency relationships of the first digital credential. In some cases, the dependency relationship storage module 230 can indicate that the first digital credential is valid and available for use independent of any other digital credential. In response to the first digital credential being used to access a protected or secure resource, the access condition module 210 can disable the OTP generation module 220 to prevent generation of an OTP that can be used to access a VPN. In other cases, the use of the first digital credential can enable the OTP generation module 220 to allow or generate OTPs after the first digital credential has been used to enter a protected area or access a secure resource.

In response to determining that the first credential is valid and available for use, the access condition module 210 can send the first credential to the communication device 240 to provide the first credential to the authentication device 110, such as a reader. In some cases, the access condition module 210 can simply display the first credential. In some cases, the access condition module 210 can access the dependency relationship storage module 230 to identify one or more other digital credentials, such as including a second digital credential, that are associated with use of the first digital credential. In such cases, the dependency relationship storage module 230 provides identifiers of the other digital credentials to the access condition module 210. The access condition module 210 can then activate, validate, deactivate, and/or invalidate one or more of the other digital credentials based on use of the first digital credential.

For example, the access condition module 210 can store a validity period or expiration time for the second digital credential that becomes valid in response to use of the first digital credential. This allows a user to access the second digital credential during the validity period and/or before the expiration time. In response to receiving a user request to access the second digital credential, the access condition module 210 can retrieve the validity period and/or expiration time of the second digital credential. The access condition module 210, in response to determining that the second digital credential is valid (e.g., the current time is prior to the expiration time of the second digital credential), the access condition module 210 provides the second digital credential to the authentication device 110 via the communication device 240.

In some cases, the use of the first digital credential disables use of another digital credential. In such cases, the access condition module 210 can access the dependency relationship storage module 230 to identify one or more other digital credentials, such as including a second digital credential, that are associated with use of the first digital credential. The dependency relationship storage module 230 can provide identifiers of the other digital credentials to the access condition module 210. The access condition module 210 can then deactivate and/or invalidate the second digital credential based on use of the first digital credential. This prevents the second digital credential from being used once the first digital credential has been used. In some examples, the second digital credential can become activated again after the first digital credential is used again. In some cases, the second digital credential is activated/deactivated based on a state of the first digital credential. For example, the state of the first digital credential can indicate that the first digital credential has been used to access or gain entry into a restricted area. In such cases, the second digital credential can become invalidated and remain invalidated while the state of the first digital credential indicates that the first digital credential has been used to access or gain entry into a restricted area. The access condition module 210 can receive an update to the state of the first digital credential, such as indicating that the first digital credential has been used to leave or exit from a restricted area. In such cases, the second digital credential can become valid for use and remain valid while the updated state of the first digital credential indicates that the first digital credential has been used to leave the restricted area.

The access condition module 210 can be used to measure proximity to one or more authentication devices 110. The access condition module 210 can enable or disable certain digital credentials in response to determining that the proximity to the one or more authentication devices 110 is within or outside a threshold. For example, the access condition module 210 can enable certain digital credentials in response to determining that the proximity to the one or more authentication devices 110 is within a threshold distance. For example, the access condition module 210 can disable certain digital credentials in response to determining that the proximity to the one or more authentication devices 110 is outside a threshold distance. For example, the access condition module 210 can disable certain digital credentials in response to determining that the proximity to the one or more authentication devices 110 is within a threshold distance. For example, the access condition module 210 can enable certain digital credentials in response to determining that the proximity to the one or more authentication devices 110 is outside a threshold distance.

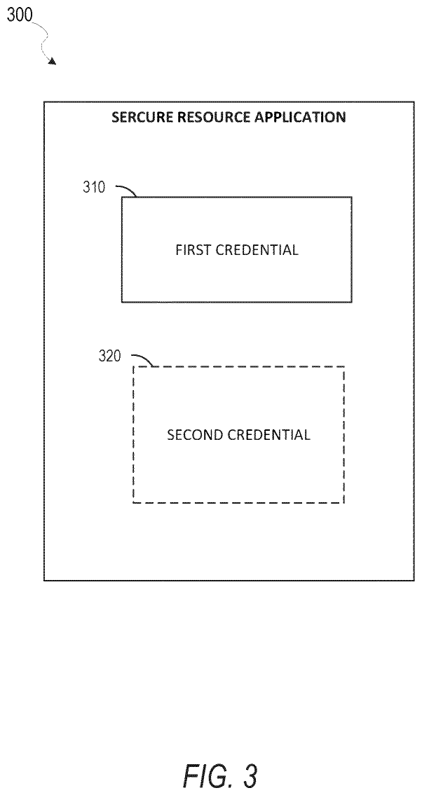

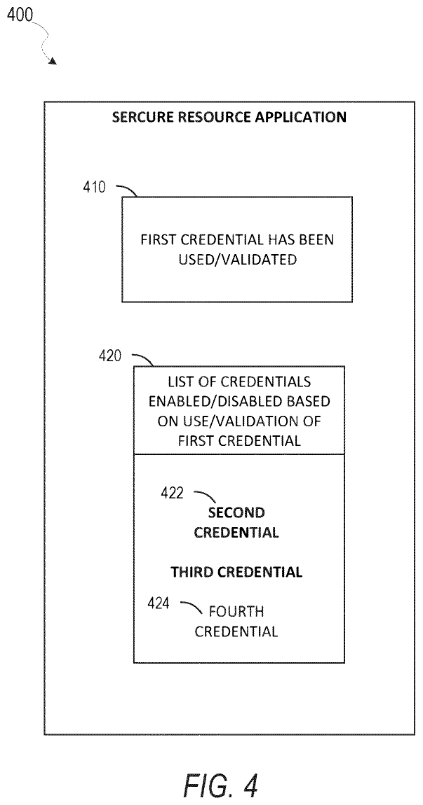

In some examples, the client device 120 can present a user interface, such as the user interfaces 300 and 400 shown in FIG. 3 and FIG. 4. The user interface 300 can be presented to a user and can list a plurality of digital credentials that have been stored and associated with the user. The plurality of digital credentials can include a first credential 310 and a second credential 320. In some cases, the client device 120 can determine that the second credential 320 has a dependency relationship with the first credential 310. The dependency relationship can specify that the second credential 320 is only available and valid in response to the first credential 310 being used or available. The client device 120 can determine that the first credential 310 has not yet been used to access a secure or protected resource. In such cases, the client device 120 can present a visual indicator with the second credential 320 indicating that the second credential is not yet valid.

The user interface 300 can visually distinguish valid credentials from invalid credentials (shown with a dotted line). In an example, the second credential 320 is presented in a dotted box to indicate that the second credential 320 is not yet active and valid, such as due to the dependency relationship with one or more other credentials. The first credential 310 is presented with a solid box to indicate that the first credential 310 is valid and available.

The user interface 300 can receive input that selects the first credential 310, such as by tapping a region of the screen in which the first credential 310 is presented. In response, the client device 120 transmits the first credential 310 to an authentication device 110. The client device 120 can receive a communication from the authentication device 110 indicating that the first credential 310 has successfully been used or validated. In response, the client device 120 can access a dependency relationship list associated with the first credential 310 to identify one or more other credentials that are activated/inactivated based on use of the first credential 310. For example, the client device 120 can present the user interface 400.

The user interface 400 can present a message 410 indicating that the first credential has been used and/or validated. The user interface 400 can present a list 420 of one or more other credentials that are activated/inactivated based on use of the first credential 310. The list 420 can include a second credential 422 (corresponding to the second credential 320) that is now valid and displayed with a first visual attribute (e.g., in a first color or in bold). The list 420 can include a fourth credential 424 that becomes deactivated by the use of the first credential 310. The fourth credential 424 can be displayed with a second visual attribute (e.g., in a second color or font) that is different from the first visual attribute. The second visual attribute indicates that the fourth credential 424 has become invalidated. The client device 120 can receive input that selects the second credential 422 and can provide the second credential 422 to an authentication device 110 to use or access a protected or secure resource. In some cases, use of the second credential 422 can activate the fourth credential 424.

For example, the first credential 310 can include an identity card and the second credential 320 can include a boarding pass. Once the first credential 310 is authenticated or validated by a reader, such as at a particular location (e.g., an airport), the second credential 320 becomes unlocked for a period of time (e.g., 12 hours). The second credential 320 can be selected to present a barcode or to transmit a token to a boarding pass reader at the same particular location or within a threshold distance of the particular location.

As another example, the first credential 310 can represent a training certificate with a validity period. In response to the client device 120 determining that the training certificate is currently valid, the client device 120 activates the second credential 320. In this case, the second credential 320 can be used to access a PACS device to enter an area restricted to individuals who have a valid training certificate.

As another example, the first credential 310 can include a key to enter a protected area. Once the first credential 310 is used to enter the protected area, the second credential 320 can become validated for generating an OTP or obtaining an electronic certificate for accessing a computing device within the protected area. In another example, once the first credential 310 is used to enter the protected area, the second credential 320 can become invalidated for preventing generation of an OTP for accessing the computing device within the protected area.

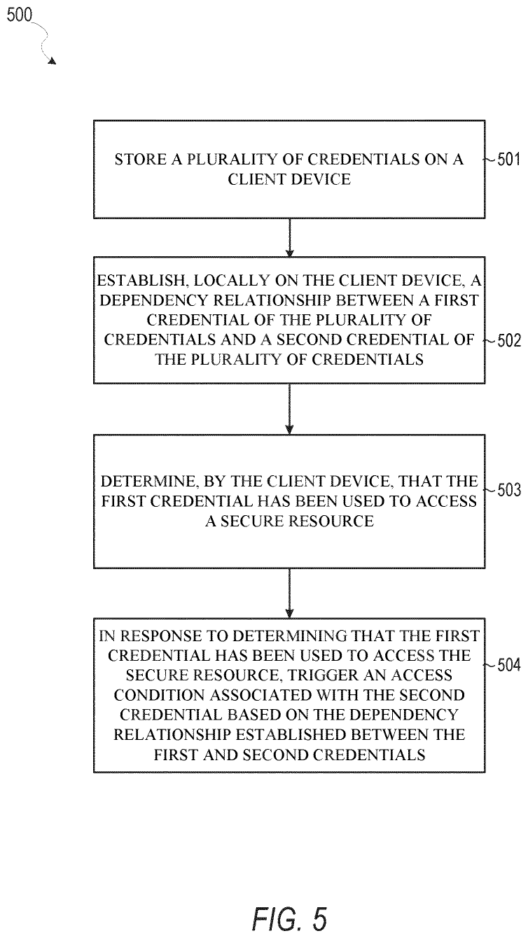

FIG. 5 is a flowchart illustrating example process 500 of the authentication system 100, according to example embodiments. The process 500 may be embodied in computer-readable instructions for execution by one or more processors such that the operations of the process 500 may be performed in part or in whole by the functional components of the authentication system 100; accordingly, the process 500 is described below by way of example with reference thereto. However, in other embodiments, at least some of the operations of the process 500 may be deployed on various other hardware configurations. Some or all of the operations of process 500 can be in parallel, out of order, or entirely omitted.

At operation 501, the authentication system 100 stores a plurality of credentials on a client device 120, as discussed above.

At operation 502, the authentication system 100 establishes, locally on the client device 120, a dependency relationship between a first credential of the plurality of credentials and a second credential of the plurality of credentials, as discussed above.

At operation 503, the authentication system 100 determines, by the client device 120, that the first credential has been used to access a secure resource, as discussed above.

At operation 504, the authentication system 100, in response to determining that the first credential has been used to access the secure resource, triggers an access condition associated with the second credential based on the dependency relationship established between the first and second credentials, as discussed above.

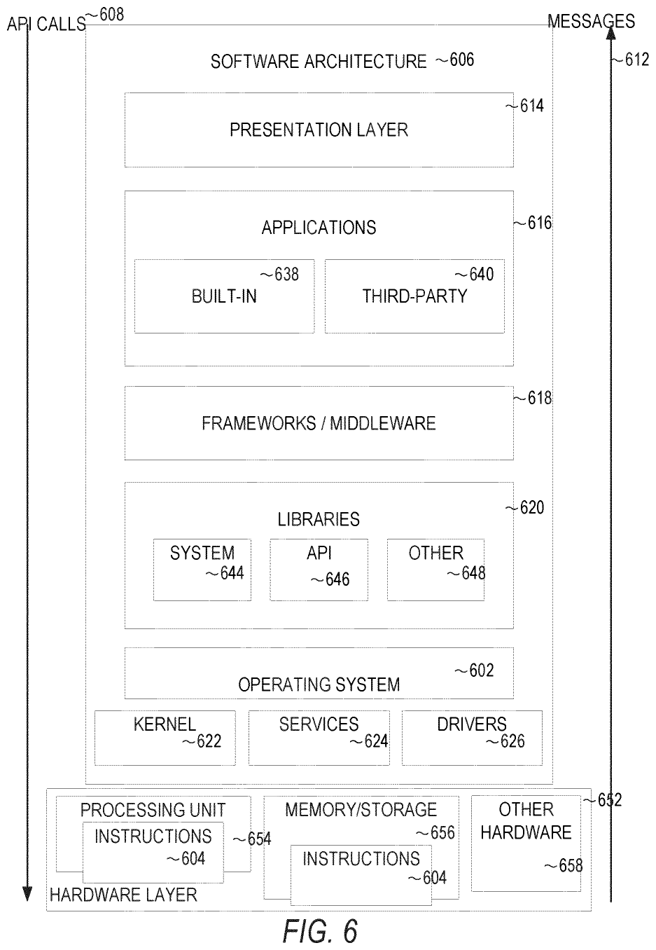

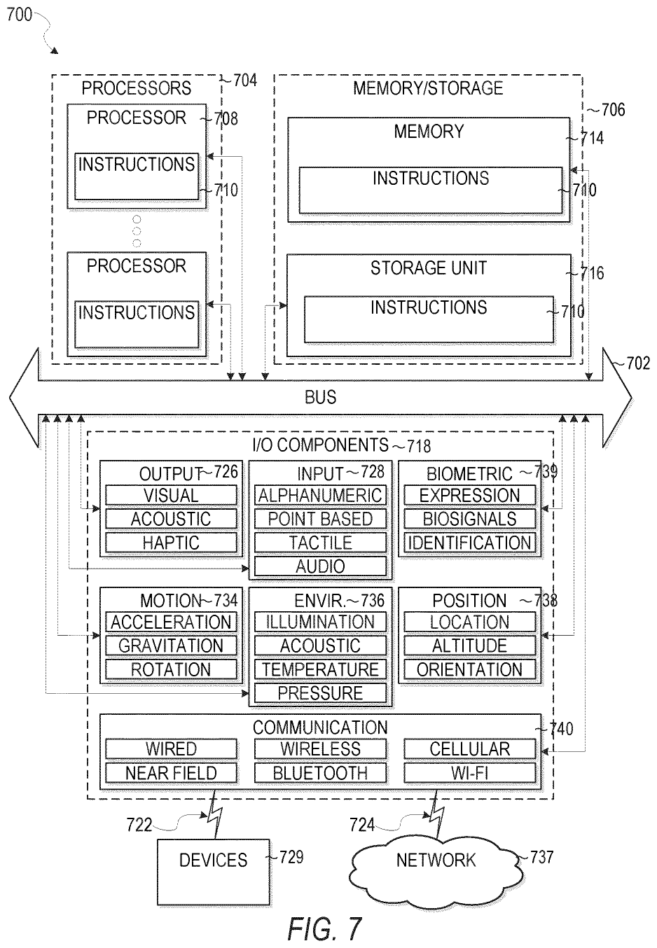

FIG. 6 is a block diagram illustrating an example software architecture 606, which may be used in conjunction with various hardware architectures herein described. FIG. 6 is a non-limiting example of a software architecture and it will be appreciated that many other architectures may be implemented to facilitate the functionality described herein. The software architecture 606 may execute on hardware such as machine 700 of FIG. 7 that includes, among other things, processors 704, memory 714, and input/output (I/O) components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage devices memory/storage 656, which also have executable instructions 604. The hardware layer 652 may also comprise other hardware 658. The software architecture 606 may be deployed in any one or more of the components shown in FIG. 1.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke API calls 608 through the software stack and receive messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, BLE drivers, UWB drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624 and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPREG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/devices.

The frameworks/middleware 618 (also sometimes referred to as middleware) provide a higher-level common infrastructure that may be used by the applications 616 and/or other software components/devices. For example, the frameworks/middleware 618 may provide various graphic user interface functions, high-level resource management, high-level location services, and so forth. The frameworks/middleware 618 may provide a broad spectrum of other APIs that may be utilized by the applications 616 and/or other software components/devices, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built-in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed.

As such, the instructions 710 may be used to implement devices or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a STB, a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. In an example embodiment, the processors 704 (e.g., a CPU, a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 708 and a processor 712 that may execute the instructions 710. The term “processor” is intended to include multi-core processors 704 that may comprise two or more independent processors (sometimes referred to as “cores”) that may execute instructions contemporaneously. Although FIG. 7 shows multiple processors 704, the machine 700 may include a single processor with a single core, a single processor with multiple cores (e.g., a multi-core processor), multiple processors with a single core, multiple processors with multiple cores, or any combination thereof.

The memory/storage 706 may include a memory 714, such as a main memory, or other memory storage, instructions 710, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a LED display, a LCD, a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 739, motion components 734, environmental components 736, or position components 738 among a wide array of other components. For example, the biometric components 739 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 737 or devices 729 via coupling 724 and coupling 722, respectively. For example, the communication components 740 may include a network interface component or other suitable device to interface with the network 737. In further examples, communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 729 may be another machine or any of a wide variety of peripheral devices (e.g., a peripheral device coupled via a USB).

Moreover, the communication components 740 may detect identifiers or include components operable to detect identifiers. For example, the communication components 740 may include RFID tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geo-location, location via Wi-Fi® signal triangulation, location via detecting an NFC beacon signal that may indicate a particular location, and so forth.

### Glossary

“CARRIER SIGNAL” in this context refers to any intangible medium that is capable of storing, encoding, or carrying transitory or non-transitory instructions for execution by the machine, and includes digital or analog communications signals or other intangible medium to facilitate communication of such instructions. Instructions may be transmitted or received over the network using a transitory or non-transitory transmission medium via a network interface device and using any one of a number of well-known transfer protocols.

“COMMUNICATIONS NETWORK” in this context refers to one or more portions of a network that may be an ad hoc network, an intranet, an extranet, a VPN, a LAN, a BLE network, a UWB network, a WLAN, a WAN, a WWAN, a metropolitan area network (MAN), the Internet, a portion of the Internet, a portion of the PSTN, a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device, or other tangible media able to store instructions and data temporarily or permanently and may include, but is not limited to, RAM, ROM, buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a FPGA or an ASIC. A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output.

Hardware components may also initiate communications with input or output devices and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a CPU, a RISC processor, a CISC processor, a GPU, a DSP, an ASIC, a RFIC, or any combination thereof. A processor may further be a multi-core processor having two or more independent processors (sometimes referred to as “cores”) that may execute instructions contemporaneously.

Changes and modifications may be made to the disclosed embodiments without departing from the scope of the present disclosure. These and other changes or modifications are intended to be included within the scope of the present disclosure, as expressed in the following claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

1. A method comprising:
storing a plurality of credentials on a client device;
establishing, locally on the client device, a dependency relationship between a first credential of the plurality of credentials and a second credential of the plurality of credentials;
determining, by the client device, that the first credential has been used to access a secure resource; and
in response to determining that the first credential has been used to access the secure resource, triggering an access condition associated with the second credential based on the dependency relationship established between the first and second credentials.

2. The method of claim 1, further comprising:
unlocking the second credential in response to triggering the access condition to enable use of the second credential to access another secure resource.

3. The method of claim 2, wherein the second credential is unlocked for a threshold period of time.

4. The method of claim 1, further comprising preventing use of the second credential until the first credential is used to access the secure resource.

5. The method of claim 1, further comprising:
locking the second credential in response to triggering the access condition to prevent use of the second credential to access another secure resource.

6. The method of claim 5, wherein the second credential is locked for a threshold period of time.

7. The method of claim 1, wherein the secure resource includes a physical access control system (PACS), wherein the first credential comprises an electronic key to enter the PACS, and wherein the second credential comprises an electronic certificate to log in to a computing device within a physical region protected by the PACS.

8. The method of claim 7, wherein the electronic certificate enables a user to log in to the computing device after the electronic key is used to enter the physical region protected by the PACS.

9. The method of any one of claim 7, wherein the electronic certificate prevents a user from logging into the computing device in response to determining that the electronic key has been used to leave the physical region protected by the PACS.

10. The method of claim 1, further comprising:
receiving a request to use the second credential to access another secure resource; and
in response to receiving the request, accessing the dependency relationship to identify one or more access conditions associated with the second credential, the one or more access conditions being associated with one or more credentials of the plurality of credentials, the one or more credentials comprising the first credential.

11. The method of claim 10, further comprising:
querying the first credential based on the dependency relationship to determine a last time that the first credential was used; and
in response to determining that the last time the first credential was used is within a threshold period of time, enabling use of the second credential to access the another secure resource.

12. The method of claim 1, further comprising:
receiving a request to use the first credential to access the secure resource;
in response to receiving the request, establishing a physical or wireless connection with a physical access control system (PACS); and
sending the first credential over a physical or wireless connection from the client device to the PACS to obtain access to the secure resource.

13. The method of claim 1, wherein the access condition enables or disables use of the second credential based on proximity of the client device to an external device.

14. The method of claim 13, further comprising determining the proximity of the client device to the external device using a short-range communication protocol comprising at least one of Bluetooth, ultra-wideband (UWB) communication protocol, or Near Field Communication (NFC).

15. The method of claim 1, wherein the first credential comprises an identity document comprising a digital signature and validity period, and wherein the second credential comprises a boarding document.

16. The method of claim 15, wherein triggering the access condition comprises validating the boarding document and maintaining the boarding document in a valid state for the validity period in response to determining that the identity document has been authenticated based on the digital signature.

17. The method of claim 1, wherein the secure resource includes a physical access control system (PACS), wherein the first credential comprises an electronic key to enter the PACS, and wherein the second credential comprises a one-time-password (OTP) generated by an OTP generator to obtain access to a computing device over a virtual private network (VPN), further comprising disabling the OTP generator in response to determining that the electronic key has been used to enter a physical region protected by the PACS.

18. The method of claim 1, wherein the first credential is associated with a specialized training certificate of a user of the client device, wherein triggering the access condition comprises unlocking the second credential for accessing a physical access control system (PACS), further comprising:
receiving a request to use the second credential to access the PACS;
in response to receiving the request, determining that the specialized training certificate associated with the first credential is valid; and
enabling use of the second credential to access the PACS in response to determining that the specialized training certificate associated with the first credential is valid.

19. A system comprising:
one or more processors configured to perform operations comprising:
storing a plurality of credentials on a client device;
establishing, locally on the client device, a dependency relationship between a first credential of the plurality of credentials and a second credential of the plurality of credentials;
determining, by the client device, that the first credential has been used to access a secure resource; and
in response to determining that the first credential has been used to access the secure resource, triggering an access condition associated with the second credential based on the dependency relationship established between the first and second credentials.

20. A non-transitory computer-readable medium comprising non-transitory computer-readable instructions that, when executed by one or more processors, configure the one or more processors to perform operations comprising:
storing a plurality of credentials on a client device;
establishing, locally on the client device, a dependency relationship between a first credential of the plurality of credentials and a second credential of the plurality of credentials;
determining, by the client device, that the first credential has been used to access a secure resource; and
in response to determining that the first credential has been used to access the secure resource, triggering an access condition associated with the second credential based on the dependency relationship established between the first and second credentials
